(19) United States
(12) Patent Application Publication
(10) Pub. No.: US 2009/0161930 A1
(43) Pub. Date: Jun. 25, 2009

(54) SYSTEM AND METHOD FOR PROCESSING AND READING INFORMATION ON A BIOLOGICAL SPECIMEN SLIDE

(75) Inventor: Michael Zahniser, Needham, MA (US)

Correspondence Address: VISTA IP LAW GROUP LLP, 12930 Saratoga Avenue, Suite D-2, Saratoga, CA, 95070, US

(73) Assignee: CYTYC CORPORATION, Marlborough, MA (US)

(21) Appl. No.: 12/335,348

(22) Filed: Dec. 15, 2008

Related U.S. Application Data
(60) Provisional application No. 61/015,177, filed on Dec. 19, 2007.

(51) Int. Cl. G06K 9/00

(52) U.S. Cl. 382/128

(57) ABSTRACT

A method for processing an image of a biological specimen slide, the image comprising a plurality of characters associated with the biological specimen slide. In one such embodiment, the method includes representing the plurality of characters as respective objects, grouping the objects into a plurality of respective groups of objects based on their locations relative to each other, selecting at least one of the groups of objects, and performing optical character recognition on characters corresponding to the objects of each selected group.

### RELATED APPLICATION DATA

The present application claims the benefit under 35 U.S.C. §119 to U.S. provisional patent application Ser. No. 61/015,177, filed Dec. 19, 2007. The foregoing application is hereby incorporated by reference into the present application in its entirety.

### FIELD OF THE INVENTION

The present inventions relate to processing data associated with biological specimen slides and, more particularly, to methods and systems for selecting characters associated with biological specimen slides and reading selected characters using optical character recognition.

### BACKGROUND

Medical professionals and cytotechnologists often prepare a biological specimen on a specimen carrier, such as a glass cytological specimen slide, and analyze cytological specimens to assess whether a patient has or may have a particular medical condition or disease. For example, it is known to examine a cytological specimen in order to detect malignant or pre-malignant cells as part of a Papanicolaou (Pap) smear test and other cancer detection tests. To facilitate this review process, automated systems focus the technician's attention on the most pertinent cells or groups of cells, while discarding less relevant cells from further review.

An initial step of this process is preparing a specimen slide. Referring to FIG. 1, a known automated slide preparation system 10 includes a container or vial 11 that holds a cytological specimen 12, e.g., cytological cervical or vaginal cellular material. The specimen 12 includes tissue and cells 14. The system 10 also includes a filter 16, a valve 18 and a vacuum chamber 20. Cells 14 are dispersed within a fluid, liquid, solution or transport medium 22 such as a preservative solution (generally referred to as “liquid 22”). During use, one end of the filter 16 is disposed in the liquid 22, and the other end of the filter 16 is coupled to a vacuum chamber 20 through the valve 18. Opening the valve 18 applies vacuum 24 to the filter 20 which, in turn, draws liquid 22 up into the filter 16.

Referring to FIG. 2, cells 14 in the drawn liquid 22 are collected by a face or bottom 26 of the filter 16. Referring to FIGS. 3 and 4, collected cells 14 can be applied to a cytological specimen carrier 30, such as a glass slide, by bringing the face 26 of the filter 16 in contact with the slide 30, thus applying a cytological specimen 32 in the form of a thin layer of cells 14 on the slide 30. A cover slip (not shown in FIGS. 1-4) is preferably adhered to the specimen 32 to fix the specimen 32 in position on the slide 30. The specimen 32 may be stained with any suitable stain, such as a Papanicolaou stain. Examples of known automated systems that operate in this manner and that have been effectively used in the past are available from Hologic, Inc., 250 Campus Drive, Marlborough, Mass. 01752.

Referring to FIGS. 3 and 4, a specimen slide 30 will often include identifying marks or indicia 34, e.g., in the form of characters such as letters and/or numbers (generally referred to as characters 34). Characters 34 may be printed or applied to a label 36 (as shown in FIGS. 3 and 4), which is affixed to a surface of the slide 30. Characters 34 may also be applied directly onto the slide 30, e.g., by etching the characters 34 into the slide 30 or by marking the slide 30, which may be done by marking a frosted section of a slide 30 using a pen or pencil. The characters 34 may provide various types of information concerning the specimen 32 and/or the patient, e.g., patient name, specimen date, specimen type, etc. As generally illustrated in FIGS. 3 and 4, one known slide preparation system 10 may include an optical character recognition (OCR) system or scanner 38. The OCR scanner 38 includes or utilizes a camera that captures images of character indicia 34 on the slide 30 or label 34 and processes the image data in order to read the characters 34.

Referring to FIG. 5, specimen slides 30 prepared using the system 10 and other components shown in FIGS. 1-4 may be processed and analyzed using a biological screening system “S” configured for imaging and presenting a biological specimen 32 located on a slide 30 to a cytotechnologist, who can then review objects of interest (OOIs) located in the biological specimen 32. The system S may include an imaging station 40 (which may include an OCR system), a server 50 and a reviewing station 60.

The imaging station 40 is configured to image the specimen 32 on the slide 30, which is typically contained within a cassette (not shown in FIG. 5) along with other slides. During the imaging process, slides 30 are removed from the respective cassettes, imaged, and returned to the cassettes in a serial fashion. During imaging, the slide 30 is mounted on the motorized stage 44, which scans the slide 30 relative to the viewing region of the microscope 43, while the camera 41 captures images over various regions of the biological specimen 32. The motorized stage 44 tracks (x,y) coordinates of the images as they are captured by the camera 41. The camera 41 captures magnified images of the specimen 32 on the slide 30 viewed through the microscope 43. The camera 41 capture images of character indicia 34 and generates a digital output to allow processing of captured images.

Image data is provided to a server 50, which may include one or more processors 51 configured to identify OOIs in a number of fields of interest (FOIs) that cover portions of the slide 30. The OOIs are provided to the reviewing station 60. The reviewing station 60 includes a microscope 61, an OCR scanner or program 62 and a motorized stage 63. The slide 30 is mounted on the motorized stage 63, and information regarding the patient and/or specimen 32 may be determined using the OCR scanner 62, which acquires images of characters 34 including numbers and/or letters. The stage 63 moves the slide 30 relative to the viewing region of the microscope 61 based on the routing plan and a transformation of the (x,y) coordinates of the FOIs determined by the processor 51 and obtained from memory 53. These (x,y) coordinates, which were acquired relative to the (x,y) coordinate system of the imaging station 40, are transformed into the (x,y) coordinate system of the reviewing station 60 using fiducial marks affixed to the slide 30. The motorized stage 63 then moves according to the transformed (x,y) coordinates of the FOIs, as dictated by the routing plan. Further aspects of a known imaging station 40, server 50 and review station are described in U.S. Pat. No. 7,006,674, the contents of which are incorporated herein by reference.

OCR scanners used in known specimen preparation and imaging/review systems have been used effectively in the past, but the manner in which information on a slide is read can be improved. For example, known OCR scanners used in slide preparation and review components may be improved by enhancing reading of desired slide indicia or characters that may be within the field of view of other unrelated indicial or characters, and reading of slide indicia at different orientations. Known OCR scanners may not be able to read characters that are arranged in different orientations, e.g., when a slide is rotated, when a label having characters is rotated, or when characters on a properly oriented label are printed or applied at an angle, particularly in the presence other characters or dark marks similar in appearance to characters that are not part of the characters of interest, thereby resulting in false readings or an inability to read the label. OCR scanners can also be expensive and may add significant cost to preparation and review systems.

### SUMMARY

One aspect of the invention is directed to a method for processing an image of a biological specimen slide, the image comprising a plurality of characters associated with the biological specimen slide. In one such embodiment, the method includes representing the plurality of characters as respective objects, grouping the objects into a plurality of respective groups of objects based on their locations relative to each other, selecting at least one of the groups of objects, and performing optical character recognition on characters corresponding to the objects of each selected group. The objects may comprise points that are locations within the image, wherein the points are grouped based on edge vector analysis. The plurality of characters will normally include at least one number, at least one letter, or a combination of one or more letters and numbers on a label affixed to the biological specimen slide.

In such embodiments, objects may be grouped based on their relative spacing, or an alignment of the objects. A group may be selected based on a number of objects within the group, for example, where each selected group has a same number of objects. In one such embodiment, the objects of two selected groups define parallel lines. In one such embodiment, at least three groups of objects are selected, and wherein optical character recognition is performed on characters corresponding to the objects of two of the at least three selected groups.

In accordance with another aspect of the invention, a method for processing an image of a biological specimen slide is provided, wherein the image comprises a plurality of characters associated with the biological specimen slide. In one such embodiment, the method includes representing the plurality of characters as respective objects, grouping the objects into a plurality of respective linear groups of objects based upon an examination of edge vectors connecting respective pairs of objects and selecting respective edges that result in groups of objects satisfying a pre-determined criteria, selecting at least one of the groups of objects, and performing optical character recognition on characters corresponding to objects of each selected group. Again, the objects may be points that are locations within the image, wherein edge vectors connecting all respective pairs of points are examined. By way of non-limiting example, a shortest one of the edge vectors may be initially examined. In one such embodiment, the pre-determined criteria may be a spacing of the objects relative to each other. In another embodiment, the pre-determined criteria may be an alignment of the objects. By way of non-limiting example, a group may be selected based on a number of objects within the group.

In accordance with still another aspect of the invention, a system is provided for processing an image of a biological specimen slide, the image comprising a plurality of characters associated with the biological specimen slide. In one such embodiment, the system includes a camera configured to acquire an image of a biological specimen slide, the image comprising a plurality of characters associated with the biological specimen slide, a processor operably coupled to the camera and configured to process the image by (i) representing the plurality of characters as respective objects, (ii) grouping the objects into a plurality of respective groups of objects based on their locations relative to each other, and (iii) selecting at least one of the groups of objects, wherein the processor is further configured to perform optical character recognition on characters corresponding to the objects of each selected group. In one embodiment, the processor is configured to represent characters associated with the biological specimen slide as points that are locations within the image. In one embodiment, the processor is configured to group the points based on edge vector analysis. Again, the characters are normally numbers, letters, or a combination of letters and numbers on a label affixed to the biological specimen slide.

Other aspects and features of various embodiments are described herein in conjunction with the accompanying drawings.

### BRIEF DESCRIPTION OF THE DRAWINGS

Referring now to the drawings in which like reference numbers represent corresponding parts throughout and in which:

FIG. 1 illustrates a known specimen slide preparation system;

FIG. 2 is a bottom view of a face of a known cytological filter including cells collected using the preparation system shown in FIG. 1;

FIG. 3 illustrates a known method of applying cells collected by a cytological filter shown in FIGS. 1 and 2 to a specimen slide;

FIG. 4 shows a specimen slide having cells applied by a cytological filter shown in FIGS. 1-3;

FIG. 5 illustrates a known specimen imaging/review system;

FIG. 6 illustrates a system including pre-OCR components or software according to one embodiment and known or conventional OCR components or software for processing characters associated with a biological specimen slide and selected or extracted using embodiments;

FIG. 7 is a flow chart illustrating a method of processing and reading information associated with a biological specimen slide according to one embodiment;

FIG. 8 is an image of a specimen slide label having characters and being displayed against an underlying label and background including other characters;

FIG. 9 illustrates representation of characters and pertinent markings in the image shown in FIG. 8 as non-character elements according to one embodiment;

FIG. 10 illustrates grouping of non-character elements shown in FIG. 9 according to one embodiment;

FIG. 11 illustrates selection of groups having a pre-determined number of non-character objects shown in FIG. 10 according to one embodiment;

FIG. 12 illustrates the result of selection of groups of objects as shown in FIG. 11;

FIG. 13 illustrates label characters corresponding to the objects shown in FIG. 12;

FIG. 14 illustrates selection of groups having a pre-determined number of objects from a set of groups having a pre-determined number of objects according to one embodiment;

FIG. 15A illustrates criteria for selecting a group having a pre-determined number of objects based on first and second lines defined by two groups being parallel and having aligned center points;

FIG. 15B illustrates criteria for eliminating a group having a pre-determined number of objects based on first and second lines defined by two groups being parallel and having misaligned center points;

FIG. 15C illustrates criteria for eliminating a group having a pre-determined number of objects based on first and second lines defined by two groups being non-parallel and having aligned center points;

FIG. 16 further illustrates selection and elimination of certain groups of objects based on analysis involving criteria shown in FIGS. 15A-C;

FIG. 17A generally illustrates normal nuclei that may be analyzed with embodiments of a pre-OCR software; and

FIG. 17B generally illustrates abnormal or cancerous nuclei that may be analyzed with embodiments of a pre-OCR software program.

### DETAILED DESCRIPTION OF ILLUSTRATED EMBODIMENTS

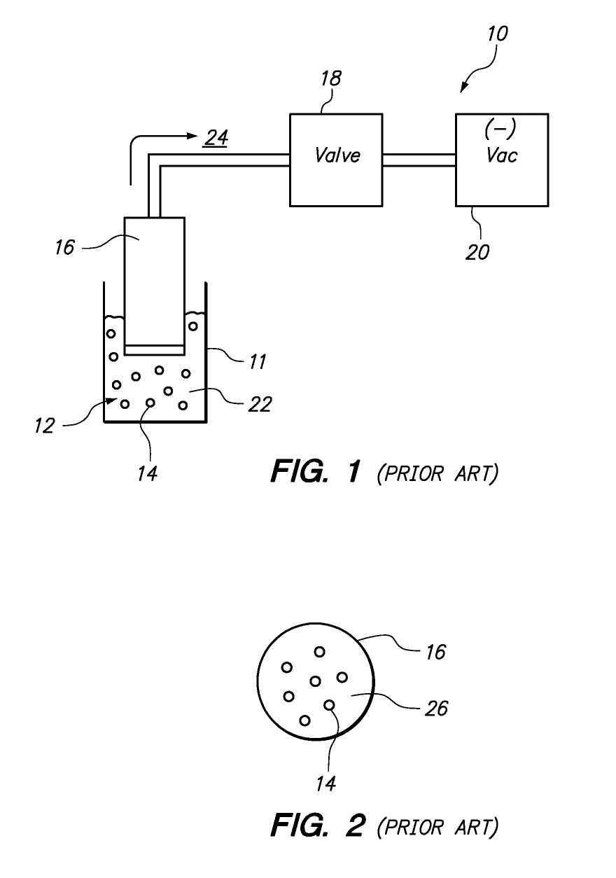

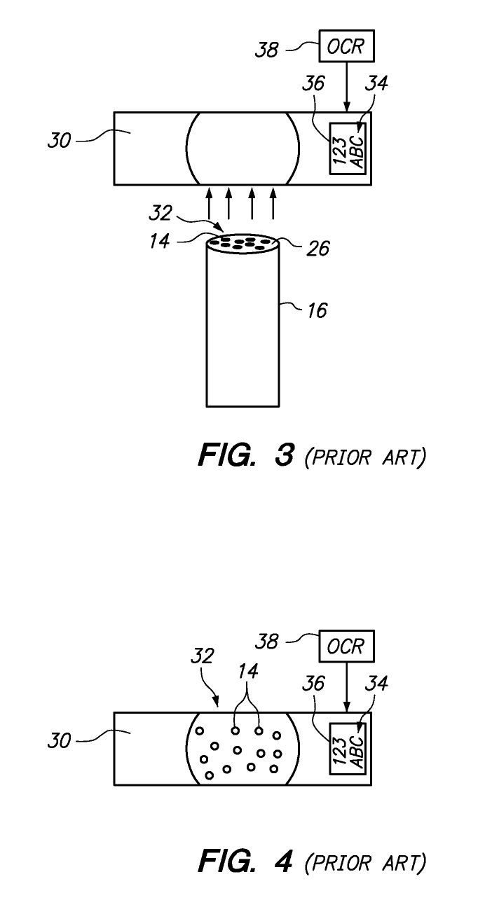

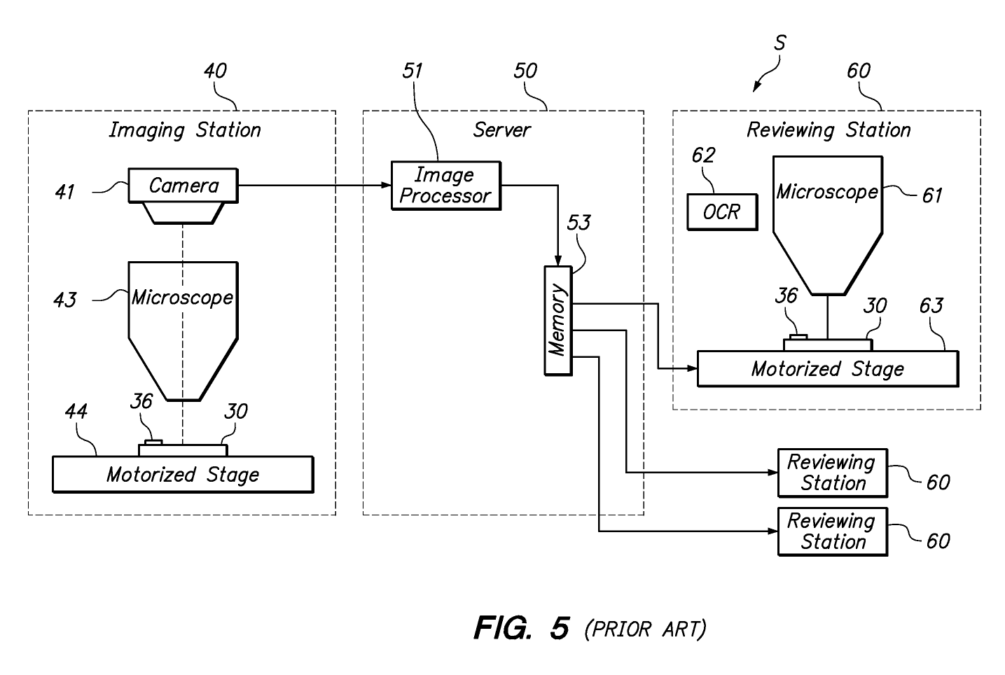

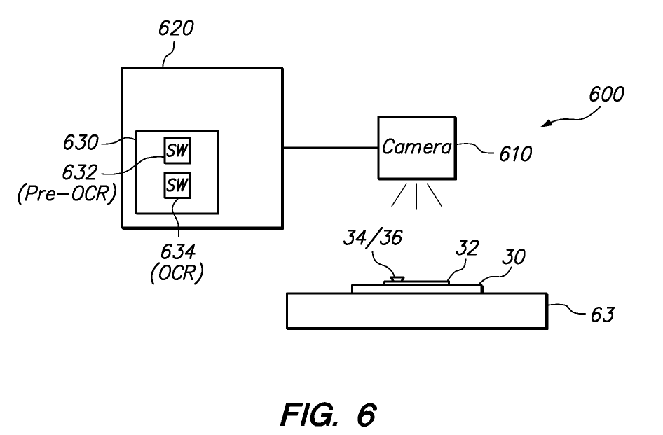

Referring to FIG. 6, a system 600 constructed according to one embodiment includes a camera 610, a controller or processor 620, and a memory 630. The system 600 is configured for processing and selecting or extracting certain characters of an initial set of characters associated with a biological specimen slide 30, and then using a conventional OCR scanner or program to read the selected characters. The system 600 may be a component of, or operably coupled to, a slide preparation system or a specimen reviewing station, e.g., as shown in FIGS. 1-5.

The camera 610 may be a digital camera and is used to acquire one or more images of characters 34 associated with a specimen slide 30. Characters 34 in the form of numbers and/or letters may be attached to or printed on a label 36, which is affixed to the slide 30, or etched into or marked on the slide 30. Characters 34 may relate to or identify a patient, a specimen 32, a system that prepared the specimen 32 and other types of information associated with a biological specimen 32, slide 30 or patient. For ease of explanation, reference is made to characters 34 printed on a label 36 affixed to a slide 30.

The processor 620 may be a personal computer, server, microprocessor or microcontroller (generally referred to as processor 620). The memory 630 may be a hard drive, Random Access Memory (RAM), Read Only Memory (ROM), and any other suitable memory. The memory 630 stores computer executable instructions, pre-OCR software 632 and the OCR program 634 that are executed by the processor 620 to process images acquired by the digital camera 610. A first, pre-OCR software 632, which is not a known or conventional OCR program or OCR scanner, is configured to process images acquired by the digital camera 610 according to embodiments. The conventional OCR program 634 is then used to read certain characters 34 identified using the pre-OCR software 632.

Although FIG. 6 illustrates a system 600 in which the pre-OCR software 632 and the OCR program 634 are stored in memory 630 in a processor 620, it should be understood that the processor 620 and memory 630 are separate components. Further, the pre-OCR software 632 and the OCR program 634 may be stored in the same memory 630 or in different memories or on portable storage media. For example, the OCR program 634 may be stored in a hard drive on a computer 620, whereas the pre-OCR software 632 may be loaded from an optical disc or other portable storage media. Additionally, although the OCR program 634 is shown as being stored in memory 620, the OCR program 634 may be part of a conventional OCR scanner. Thus, FIG. 6 is provided to generally illustrate that the pre-OCR software 632 of embodiments is different from known OCR programs 634.

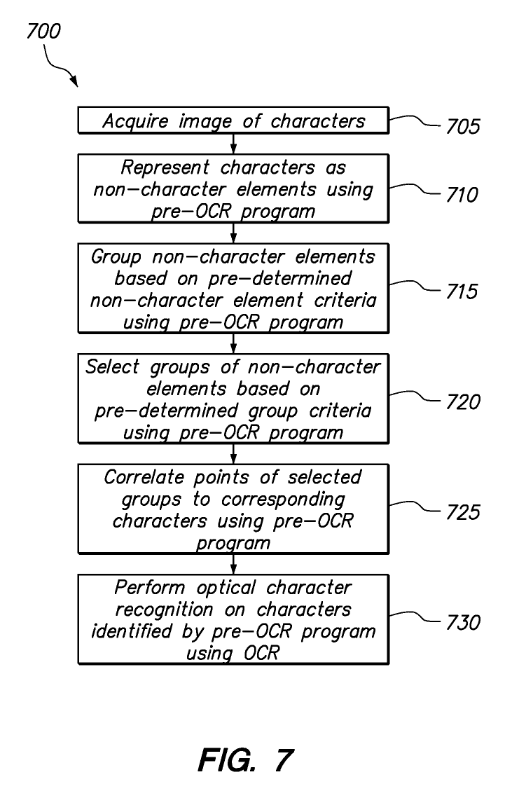

Further, although reference is made to a pre-OCR software program 632, the same steps may be executed using hardware and a combination of hardware and software. Additionally, although embodiments eliminate the need for a separate OCR scanner by use of execution of a known OCR program 634, the OCR program 634 may be a part of a separate OCR scanner, and the pre-OCR software 632 may be stored and executed independently of the OCR program 634. For ease of explanation, reference is made to the pre-OCR software 632 and the OCR program 634 being stored in memory 630. FIGS. 7-17B further illustrate how embodiments may be implemented and different processes and determinations performed by the pre-OCR software 632 according to embodiments for extracting, identifying or selecting certain characters 34, which are then processed using the conventional OCR program 634.

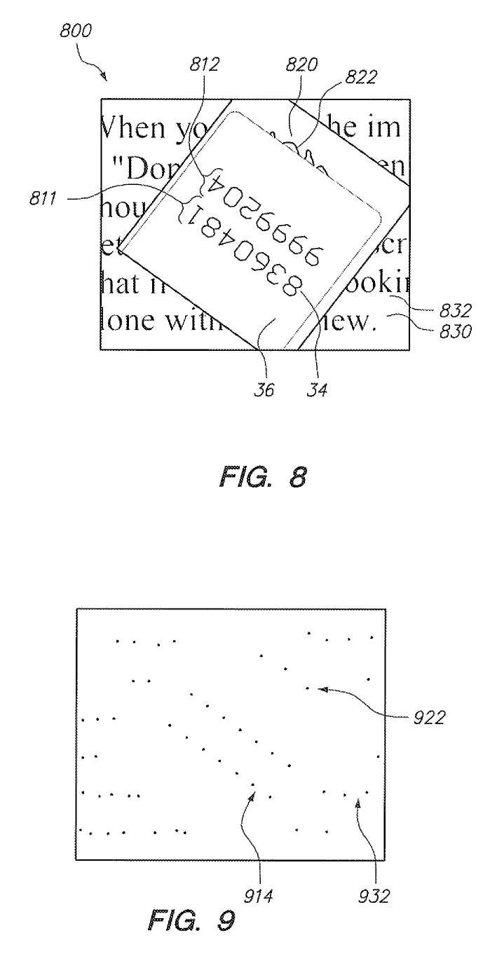

Referring to FIG. 7, the pre-OCR software 632 and the conventional OCR program 634 may be configured to be executed by the processor 620 and perform a method 700 of processing and reading information associated with a biological specimen slide 30. The method 700 includes acquiring an image of characters associated with a biological specimen slide 30 at stage 705 using the digital camera 610. FIG. 8 illustrates an example of an image 800 of a label 36 of a ThinPrep slide 30 having two rows 811, 812, each row having seven characters 34. In the illustrated example, the characters 34 are in the form of numbers, but characters 34 may also be letter and a combination of numbers and letters and may be used for various identification purposes.

In the illustrated example, the label 36 is shown as being applied over another label 820 having other characters or markings 822 that are not related to the rows of seven characters 34. Both labels 36, 820 are shown against background 830 having other unrelated characters 832 for purposes of illustrating how embodiments can effectively extract relevant characters 34 from a set of characters within a field of view and eliminate certain characters 822 and 832 from being processed by an OCR program 634. In the illustrated example, the characters 832 of the background 830 are oriented in their normal, readable manner, whereas the slide label 36 and characters 34 are rotated at an angle relative to the characters 832 of the background 830.

Referring again to FIG. 7, and with further reference to FIG. 9, at stage 710, the pre-OCR software 632 of embodiments is executed so that characters 34 of the label 36, characters 822 of the underlying label 820, and the characters 832 of the background 830 are converted or transformed into non-character elements or objects such as points or locations within the image or within reference frame of the image (generally referred to as points). FIG. 9 illustrates the result of stage 710 by representing each character 34 of the slide label 36 as a point 914, each character 822 of the underlying label 820 as a point 922, and each character 832 of the background 830 as a point 932. For ease of explanation, this specification refers to characters 34 when referring to characters generally, and refers to points 914 when referring to points generally.

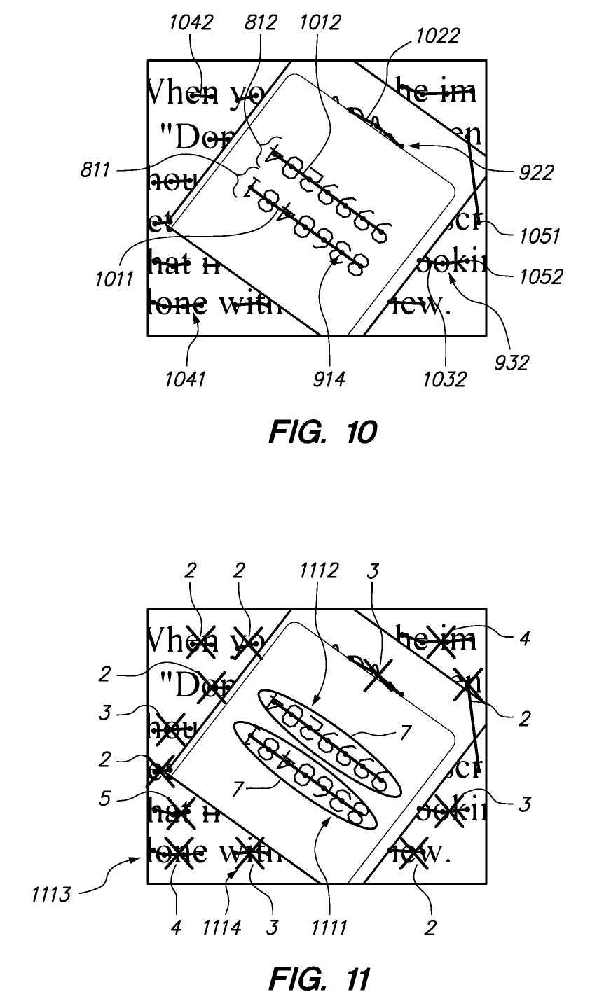

Referring again to FIG. 7, and with further reference to FIG. 10, at stage 715, the pre-OCR software 632 of embodiments is executed so that non-character elements, objects or points are grouped together based on pre-determined non-character element, object or point criteria (generally referred to as criteria). According to one embodiment, criteria for grouping of points include proximity or closeness, even spacing between points in a group, and/or alignment, e.g., whether adding a point to a line would result in misalignment or an unacceptable variance from a straight line. Thus, for example, points that are separated from each other by a distance that is greater than a pre-determined or threshold distance will not be grouped together. As a further example, points that exhibit uneven spacing that deviates by more than a pre-determined or threshold amount will not be grouped together. Further, a point that results in misalignment relative to other points in a group or line will not be added to that group or line. Grouping of points based on these criteria is illustrated in FIG. 10.

FIG. 9 illustrates points 914 generated at stage 710, and FIG. 10 illustrates points 914 relative to the corresponding characters 34 and grouped together based on the point criteria, which may be based on whether to include or add a point 914 to a line defined by other points 914. For example, points 914 corresponding to row 811 are grouped 1011 together in the form of a line based on the point criteria, points 914 corresponding to row 812 are grouped 1012 together in the form of a line based on the point criteria, points 932 corresponding to characters 822 of an underlying label 820 are grouped 1022 together in the form of a line based on the point criteria, points 832 corresponding to characters 832 of the background 830 are grouped 1032 together in the form of a line based on the point criteria.

FIG. 10 also illustrates that use of point criteria (proximity, spacing, alignment) excludes or prevents grouping of certain points. For example, points 932 are grouped together as lines 1041 and 1042 correspond to characters 832 in the background 830 and would not be grouped together even if they exhibit similar spacing since they are too far apart from each other. Similarly, point 932 that is part of a group or line 1051 would not be added to or a group 1052 of three points 932 since this result in inconsistent spacing and misalignment.

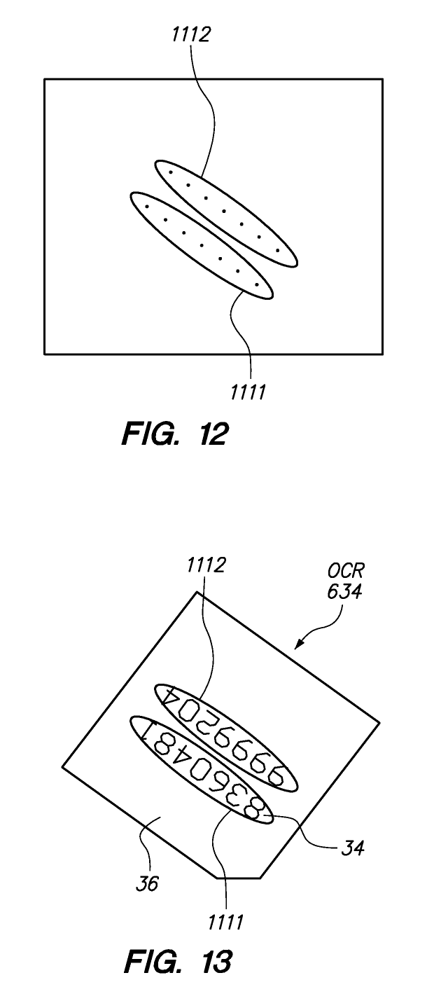

Referring again to FIG. 7, and with further reference to FIGS. 11 and 12, at stage 720, the pre-OCR software 632 of embodiments is executed so that groups 1111, 1112 of points 914 are selected after grouping is completed at stage 715 based on pre-determined group criteria. According to one embodiment, a criterion for selecting a group is the number of points 914 within the group. FIG. 12 illustrates different groups of points 914 and includes numbers identifying the number of points 914 in each group. For example, certain groups have two points, three points, four points, five points and seven points.

In the illustrated embodiment, a first group 1111 includes seven points 914, a second group 1112 also includes seven points 914, a third group 1113 includes four points 932, and a fourth group 1114 includes three points 932. According to one embodiment, e.g., for use with a ThinPrep slide, each group that is selected includes the same number of points 914, e.g., seven points 914. Accordingly, groups that do not contain seven points 914 are eliminated from further consideration. In the illustrated embodiment, all of the groups except for groups 1111 and 1112 would be eliminated based on a group being selected only if the group includes a pre-determined number of seven points 914 (which correspond to seven characters 34). The result of stage 720 is illustrated in FIG. 12, which illustrates two selected groups 1111 and 1112, each of which includes seven points 914, and which define two parallel lines having the same length as a result of even spacing between points 914 and corresponding characters 34.

Embodiments may be adapted for selection of other numbers of groups, e.g., more than two groups, and groups may have different numbers of points 914, but this specification refers to embodiments in which two groups 1111, 1112 are selected for ease of explanation. Thus, it should be understood that group criteria corresponding to seven points 914 is provided as one example of how embodiments may be implemented, and that different numbers of points 914 may be utilized for different applications and with different slide processing systems.

Referring again to FIG. 7, and with further reference to FIG. 13, at stage 725, the pre-OCR software 632 of embodiments correlates the points 941 of the selected groups 1111, 1112 to corresponding characters 34 on the label 36. Following stage 725, the pre-OCR software 632 of embodiments has been executed. Thereafter, at stage 730, conventional OCR 634 is performed on the identified or selected characters 34 corresponding to the two groups 1111, 1112 of seven points 941.

Thus, embodiments advantageously perform pre-OCR processing such that it is not necessary to perform conventional OCR processing on characters of the underlying slide and characters of the background. This simplifies OCR processing and reduces OCR errors since the OCR scanner and program can be applied to a smaller number of characters and characters in proximity to each other and having consistent spacing and alignment.

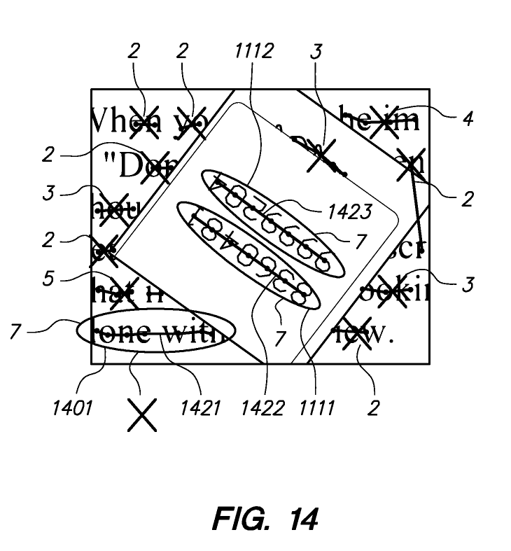

There may be instances in which grouping or clustering of points (stage 720 in FIG. 7) results in multiple groups having the same or pre-determined number of points (e.g., seven points as described above). For example, referring to FIG. 14, if groups 1113 and 1114 (FIG. 11) are combined, the resulting group 1401 includes seven points. Of course, there may be various numbers and orientations of groups having the pre-determined number of points, and groups 1113 and 1114 were combined to illustrated one example of how embodiments may be implemented.

In these instances, and based on this example, stage 720 generates three groups—two groups 1111, 1112 that are groups that should be processed with OCR 634, and one group 1401, which corresponds to background characters and should not be processed by OCR 634. The pre-OCR software 632 of embodiments may be executed to eliminate the lower left group 1401 containing seven points from further consideration by geometric analysis of lines defined by points in a group, and determining whether lines 1421, 1422 and 1423 defined by respective groups 1401, 1111, 1112 of points satisfy pre-determined line criteria. Line criteria may include whether the defined lines are substantially parallel to each other (e.g., the degree of misalignment is less than a threshold) and whether center points of the lines are off-center. According to one embodiment, the line defined by a set of points may be found using known orthogonal distance regression methods. The alignment of the lines can be checked using known geometric methods, such as examining the magnitudes of the cross products of the slopes of each line with the vector connecting the midpoints of the lines.

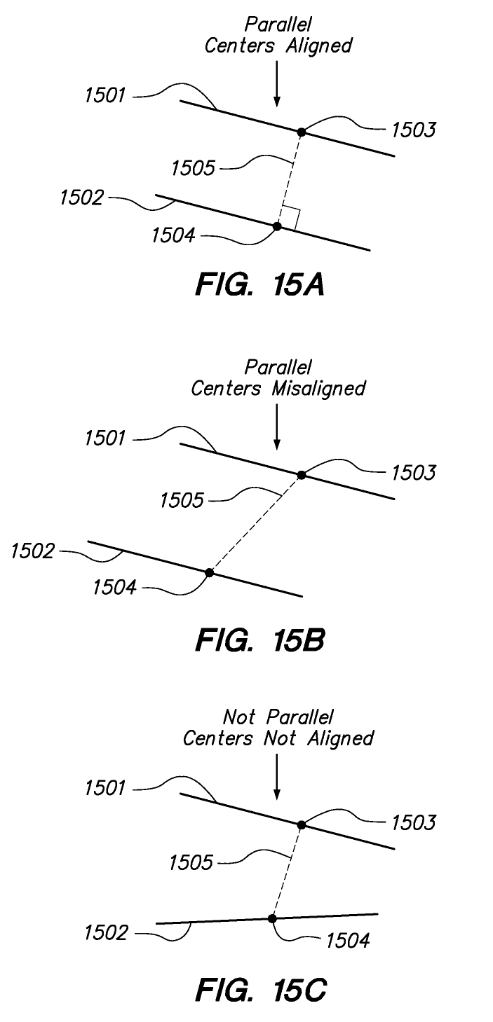

FIGS. 15A-C illustrate different arrangements of two lines 1501, 1502 defined by respective points 941. FIG. 15A shows two lines 1501 and 1502 arranged so that the spacing between the lines 1501, 1502 is substantially consistent, and the lines 1501, 1502 are substantially parallel to each other. Further, the two lines 1501, 1502 are aligned with each other since an intermediate line 1505 extending between a center point 1502 of the first line 1501 and a center point 1504 of the second line 1502 is substantially orthogonal to the first and second lines 1501, 1502. Lines 1501 and 1502 arranged as shown in FIG. 15A would be selected by the pre-OCR software 632, which executes instructions for analyzing line criteria. In contrast, FIGS. 15B and 15C illustrate two lines 1501, 1502 that are not parallel and/or not aligned with each other so that the intermediate line 1505 drawn between the center points 1503, 1504 is not at a right angle relative to the lines 1501, 1502. The pre-OCR software 632 is configured to execute instructions that would eliminate one or more groups defined by the lines until an arrangement shown in FIG. 15A is identified.

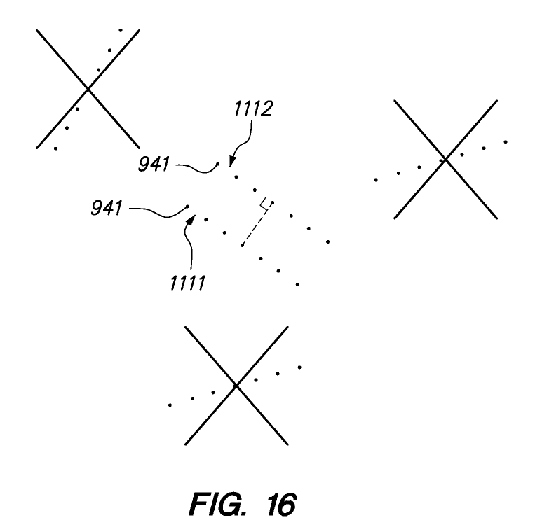

Referring again to FIG. 14, and with reference to FIGS. 15A-C, the two lines 1422, 1423 defined by points in groups 1111 and 1112 of seven points are parallel with each other and have the same length as a result of even spacing between points 914 and characters 34 such that an intermediate line extending between the center points of the lines is substantially perpendicular to the two lines (as illustrated in FIG. 15A). However, when a similar line analysis applied to, for example, line 1421 defined by points in group 1401 and line 1422 defined by points in group 1111, the resulting arrangement and line relationships are not as shown in FIG. 15A. This arrangement instead results in misaligned or skewed lines, as generally illustrated in FIG. 15C. The pre-OCR software 632 of embodiments eliminates the lower left group 1401 of seven points defined by line 1421 from further consideration based on the line criteria, leaving two groups 1111, 1112 of seven points, which define aligned and parallel lines 1422, 1423, as generally illustrated in FIG. 15A. A similar analysis may be applied to any additional groups having seven points, and the pre-OCR software 632 is programmed to perform a geometric analysis of the lines, resulting in elimination of groups of seven points 941 that do not satisfy the pre-determined line criteria and selection of groups 1111, 1112 (as generally illustrated in FIG. 16). Conventional OCE 634 may then be performed on the characters corresponding to the two groups 1111, 1112 of seven points using the conventional OCR program 634 (stage 725). In the illustrated embodiment, the two groups 1111, 1112 of seven points 941 correspond to characters 34 on a label 36 of a ThinPrep slide, but it should understood that other slide processing and review systems may utilize other identification formats, e.g., different numbers of groups and different numbers of characters in a group.

In this manner, only the characters 34 that correspond to the label 36 that desired to be read are processed by the OCR program 634. The background characters 832 are advantageously eliminated by the pre-OCR software 632 and not processed by the OCR program 634. Further, markings and/or characters 822 on the underlying label 820 are advantageously eliminated by the pre-OCR software 832 and not processed by the OCR software 834. Additionally, given the manner in which embodiments function, label characters 34 may be arranged in different orientations while still being accurately processed by OCR software 832.

For example, FIGS. 11-13 illustrate elimination of background 832 characters in a normal orientation and reading of label characters 34 rotated at an angle relative to the normal orientation. Embodiments were tested at random angles. The pre-OCR software 632 of embodiments and a conventional OCR program 634 were tested on slide labels 36 having two groups of seven numbers 34. The slide labels 36 were arranged at random angles, and 4,000 images were acquired at these different angles. The pre-OCR software 632 of embodiments was executed to perform stages 705-725 shown in FIG. 7, and then the conventional OCR program 634 was successfully used to read the numbers 34 identified by the pre-OCR software 632 at each angle, thus demonstrating that embodiments may be implemented for extracting or selecting and reading characters 34 of slide labels 36 at any angle.

Embodiments of the pre-OCR software 632 described above may be programmed and executed using various known programming languages. The following description provides one example of how the pre-OCR software 632 may be programmed and be executed by a processor 620 for detection of characters 34 that have specific orientation and spatial relationships within a group, i.e., grouping or clustering of points based on point criteria including proximity or closeness, spacing (even spacing) and alignment. In the illustrated example involving a label having rows of numbers set against an underlying label and background, the pre-OCR software is configured to select only those numbers that are aligned in a row of evenly spaced points, disregarding other numbers, which present “false alarms” within the background and underlying label.

In one embodiment, the pre-OCR software 632 software is programmed to execute an algorithm that is based on Kruskal's algorithm for the minimum spanning tree of a set of points, but the pre-OCR software 632 does not actually use Kruskal's algorithm. Kruskal's algorithm examines each edge connecting two points in a larger set of points, starting with the shortest edge, and adds each edge to the output graph only if it joins two vertices that are not yet part of the same tree. When all edges have been considered, the resulting graph is the minimum spanning tree. The pre-OCR software 632 according to one embodiment may operate in a similar manner, but tracks the mean edge vector (i.e. direction and length) for each tree in the graph. An edge is added to the graph only if the trees it joins have mean edge vectors similar to the new edge and to each other. As a result, instead of generating a single spanning tree, the pre-OCR software 632 generates a forest of trees spanning the points, where each tree has edges that are similar to each other in length and orientation. Embodiments provide methods for taking a set of points or objects in an image that have been identified as possible characters, and grouping those potential characters into potential lines of text, based on the spacing between the potential characters and their alignment relative to each other. The method can be implemented by examining all the edge vectors connecting all pairs of points, starting with the shortest vector and proceeding to the longest, and outputting only the edges that result in groups of points that match some criteria. Those criteria might be similarities in the spacing between the points in the group, in the vectors connecting the points, or in some other feature or features associated with the points.

Pre-OCR software 632 of one embodiment may be configured to take a set of objects, points or non-character elements that have been identified as possible characters, and grouping those non-character elements into potential lines of text, based on the spacing between the non-character elements and their alignment relative to each other. In one embodiment, all edge vectors connecting all pairs of non-character elements are examined, e.g., beginning with the shortest vector and proceeding to the longest vector. Edges that result in groups of non-character elements satisfying certain criteria (e.g., spacing or other criteria as described above) are output.

More specifically, pre-OCR software 632 of one embodiment may be configured to group or cluster points or vertices together by first examining each pair of vertices, and storing the following information about the edge connecting those vertices:
1. which vertices are the endpoints of the line, 2. the vector displacement \vec{v} between the endpoint vertices, and 3. the squared length \vec{v}·\vec{v} of the displacement vector. Next, the following data is associated with each vertex: 1. a unique label (related to a group of points), 2. the sum s̅ of the vectors for the edges in the group containing this vertex (initially the zero vector), and 3. the count c of edges in the group containing this vertex (initially zero).

The list of edges is sorted by the squared length. According to one embodiment, squared length is utilized because taking the square root to find the actual length may be computationally expensive, but a square root function may also be utilized if necessary. Each edge is considered, beginning with the shortest one. For each of the endpoints of the edge, the mean edge vector m̅= s̅/c (which represents the sum of all vectors) is calculated. Two vertices are grouped together only if: they are not yet part of the same group (as identified by their labels), the mean edge vector \vec{m} for each vertex has similar length to the new edge vector \vec{v} (which relates to spacing of points), and the new edge vector \vec{v} is rotated at a similar angle to the mean edge vector \vec{m} for each vertices (which relates to alignment).

The second two conditions (spacing and alignment) are checked by calculating the value of

$$\vert \frac{\vec{v} \cdot \vec{m}}{\vec{v} \cdot \vec{v}} \vert = \vert \frac{\vert \vec{v} \vert \vert \vec{m} \vert cos θ}{{\vert \vec{v} \vert}^{2}} \vert = \frac{\vert \vec{m} \vert}{\vert \vec{v} \vert} \vert cos θ \vert ,$$

which has a maximum of 1 when the new edge vector is identical to the mean vector. The value of the expression becomes lower as the difference in lengths or the difference in orientation increases. A cutoff t is chosen below which the edges are considered too dissimilar to be joined, which may be based on determining whether |\vec{v}·\vec{s}|≧t·c·(\vec{v}·\vec{v}). For vertices that are not yet joined to any other vertices, the value of both sides of the inequality is zero and therefore it is always satisfied, as desired.

When two vertices or groups of vertices are connected, the algorithm must note that they are now part of the same group. This is done using a disjoint set data structure. One vertex from each group is chosen as the “representative” of that group and stores the mean edge vector for the group. Only the values for this vertex need to be updated when two groups are merged.

When two groups are merged, the updated vector sum is the sum of the vectors for both groups, plus the new edge vector. Two vectors that are rotated 180 degrees from each other will pass the similarity check, because they represent the same displacement measured in opposite directions. But if they are added together, they will cancel each other out. Therefore, before updating the sum vector, the mean vector for each edge must be flipped if the dot product \vec{v}·\vec{s}<0. This ensures that the vectors in the sum all point in the same general direction.

The following pseudocode provides one example, of how the pre-OCR software 632 may be programmed in order to execute steps as shown in FIG. 7 and analysis of point criteria, group criteria and line criteria.

```
for each vertex
    vertex.count ← 0.
    vertex.sumX ← 0.
    vertex.sumY ← 0.
    Mark the vertex as a separate tree.
for each edge from shortest to longest
startRoot ← root of edge.start's tree.
endRoot ← root of edge.end's tree.
if startRoot = endRoot
    Skip this edge.
startDot ← edge.dx · startRoot.sumX + edge.dy · startRoot.sumY.
if startDot < 0
    startDot ← −startDot.
    startRoot.sumX ← −startRoot.sumX.
    startRoot.sumY ← −startRoot.sumY.
endDot ← edge.dx · endRoot.sumX + edge.dy · endRoot.sumY.
if endDot < 0
    endDot ← −endDot.
    endRoot.sumX ← −endRoot.sumX.
    endRoot.sumY ← −endRoot.sumY.
if startDot ≧ tolerance · startRoot.count · edge.lengthSquared and
  endDot ≧ tolerance · endRoot.count · edge.lengthSquared
    Merge the two trees.
    newRoot ← root of the merged tree.
    newRoot.count ← startRoot.count + endRoot.count + 1.
    newRoot.sumX ← startRoot.sumX + endRoot.sumX + edge.dx.
    newRoot.sumY ← startRoot.sumY + endRoot.sumY + edge.dy.
```

It should be understood that pre-OCR software 632 may be configured to represent characters as objects or non-character elements, group non-character elements based on desired proximity, spacing and alignment criteria, and select groups of non-character elements in different manners so that conventional OCR may be performed on a reduced set of characters. Accordingly, the above description and pseudocode are provided as one example, of how embodiments of pre-OCR software 632 may be implemented to select or extract characters 34 that are intended to be read by an OCR program 634

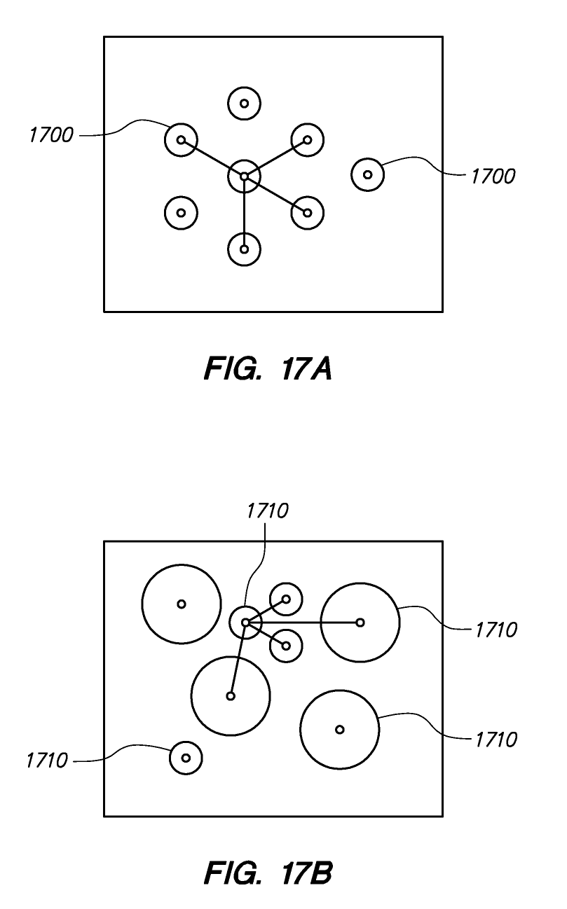

Although this specification describes use of pre-OCR software program 632 for purposes of identifying slide label characters to be read by OCR software 634, embodiments may be utilized in other cytological applications. For example, referring to FIGS. 17A and 17B, embodiments may be utilized in cytological image analysis, e.g. analyzing the spacing between cells, and selecting cells satisfying certain spacing criteria. More specifically, referring to FIG. 17A, sheets of normal tissue on a typical ThinPrep slide include a regularly spaced nuclei 1700 that are approximately the same shape and size. In contrast, referring to FIG. 17B, sheets of abnormal or cancerous cells include nuclei 1710 that are not evenly spaced and that vary in size. Embodiments of pre-OCR software 632 and analysis of criteria such as point criteria, group criteria and line criteria, can be adapted for analyzing the spacing between cells for identifying and quantifying irregular cytological cells and attributes. Embodiments of the pre-OCR software 632 can be applied to find patterns in clusters of cell nuclei and differentiate nuclei spacing arrangements in order to distinguish normal and cancerous cells. Further, embodiments may be used to analyze whether sufficient cellular material was obtained of various cell types required to form a satisfactory cytological specimen.

It should be understood that the above discussion is intended to illustrate and not limit the scope of these embodiments, and various changes and modifications may be made without departing from scope of embodiments. For example, although embodiments of the pre-OCR software of embodiments are described with reference to instructions or software stored in memory and executed by a processor, method embodiments in the form of executable instructions may also be embodied as a computer program product for use with biological specimen preparation and review systems that embodies all or part of the functionality previously described herein. Such an implementation may comprise a series of computer readable instructions either fixed on a tangible medium, such as a computer readable medium, for example, diskette, CD-ROM, ROM, or hard disk, or transmittable to a computer system, via a modem or other interface device.

Pre-OCR software of embodiments may also be programmed using various known programming languages. Additionally, although this specification describes an application involving a label of a ThinPrep slide having two groups of seven characters, other system and applications may involve different label configurations, different groupings of characters and different numbers of characters. Although one implementation of embodiments of pre-OCR software may involve a mean edge vector, embodiments may also be implemented using comparisons involve mean edge length. In addition, the minimum or maximum edge vector or edge length may be utilized rather than the mean. Alternatively, a weighted mean favoring the shorter or longer edges may be utilized. Further, the output of the pre-OCR software may be tuned as necessary by adjusting the tolerance for differences in edges or by adding a maximum edge length cutoff.

Thus, embodiments are intended to cover alternatives, modifications, and equivalents that fall within the scope of the claims.

What is claimed is:

1. A method for processing an image of a biological specimen slide, the image comprising a plurality of characters associated with the biological specimen slide, the method comprising:
representing the plurality of characters as respective objects;
grouping the objects into a plurality of respective groups of objects based on their locations relative to each other;
selecting at least one of the groups of objects; and
performing optical character recognition on characters corresponding to the objects of each selected group.

2. The method of claim 1, wherein the objects comprise points that are locations within the image.

3. The method of claim 2, wherein the points are grouped based on analysis of vectors joining pairs of points.

4. The method of claim 1, wherein the plurality of characters includes at least one number, at least one letter, or a combination of one or more letters and numbers on a label affixed to the biological specimen slide.

5. The method of claim 1, wherein the objects are grouped based on their relative spacing.

6. The method of claim 1, wherein the objects are grouped based on an alignment of the objects.

7. The method of claim 1, wherein a group is selected based on a number of objects within the group.

8. The method of claim 7, wherein each selected group has a same number of objects.

9. The method of claim 1, wherein the objects of two selected groups define parallel lines.

10. The method of claim 1, wherein at least three groups of objects are selected, and wherein optical character recognition is performed on characters corresponding to the objects of two of the at least three selected groups.

11. A method for processing an image of a biological specimen slide, the image comprising a plurality of characters associated with the biological specimen slide, the method comprising:
representing the plurality of characters as respective objects;
grouping the objects into a plurality of respective linear groups of objects based upon an examination of edge vectors connecting respective pairs of objects and selecting respective edges that result in groups of objects satisfying a pre-determined criteria;
selecting at least one of the groups of objects; and
performing optical character recognition on characters corresponding to objects of each selected group.

12. The method of claim 11, wherein the objects are points that are locations within the image.

13. The method of claim 11, wherein edge vectors connecting all respective pairs of points are examined.

14. The method of claim 11, wherein a shortest one of the edge vectors is initially examined.

15. The method of claim 11, wherein the pre-determined criteria comprises a spacing of the objects relative to each other.

16. The method of claim 11, wherein the pre-determined criteria comprises an alignment of the objects.

17. The method of claim 11, wherein the plurality of characters includes at least one number, at least one letter, or a combination of letters and numbers on a label affixed to the biological specimen slide.

18. The method of claim 1, wherein a group is selected based on a number of objects within the group.

19. A system for processing an image of a biological specimen slide, the image comprising a plurality of characters associated with the biological specimen slide, the system comprising:
a camera configured to acquire an image of a biological specimen slide, the image comprising a plurality of characters associated with the biological specimen slide; and
a processor operably coupled to the camera and configured to process the image by (i) representing the plurality of characters as respective objects, (ii) grouping the objects into a plurality of respective groups of objects based on their locations relative to each other, and (iii) selecting at least one of the groups of objects,
the processor further configured to perform optical character recognition on characters corresponding to the objects of each selected group.

20. The system of claim 19, wherein the processor is configured to represent characters associated with the biological specimen slide as points that are locations within the image.

21. The system of claim 20, wherein the processor is configured to group the points based on analysis of vectors joining pairs of points.

22. The method of claim 19, wherein the characters are numbers, letters, or a combination of letters and numbers on a label affixed to the biological specimen slide.
